(19) United States
(12) Patent Application Publication
(10) Pub. No.: US 2025/0181753 A1
(43) Pub. Date: Jun. 5, 2025

(54) LARGE LANGUAGE MODEL DATA ESCROW SERVICE

(71) Applicant: Google LLC, Mountain View, CA (US)

(72) Inventor: Samuel Green Mcveety, Seattle, WA (US)

(73) Assignee: Google LLC, Mountain View, CA (US)

(21) Appl. No.: 18/966,523

(22) Filed: Dec. 3, 2024

Related U.S. Application Data
(60) Provisional application No. 63/605,808, filed on Dec. 4, 2023.

(51) Int. Cl. G06F 21/62; G06F 16/242

(52) U.S. Cl. CPC G06F 21/6227; G06F 16/243

(57) ABSTRACT

A method for a data escrow service includes receiving, from a user device, an access query requesting generation of an access request for allowing a user associated with the user device access to one or more datasets of a plurality of datasets. The access query includes natural language text describing information associated with the one or more datasets of the plurality of datasets. The method includes determining, using a large language model (LLM) and the access query, the one or more datasets. The method includes generating the access request requesting the user gain temporary access to the one or more datasets. The method also includes providing, to the user device, a notification of the one or more datasets and the access request. The notification does not include any data from the one or more datasets.

### CROSS REFERENCE TO RELATED APPLICATIONS

This U.S. patent application claims priority under 35 U.S.C. § 119(e) to U.S. Provisional Application 63/605,808, filed on Dec. 4, 2023. The disclosure of this prior application is considered part of the disclosure of this application and is hereby incorporated by reference in its entirety.

### TECHNICAL FIELD

This disclosure relates to large language model data escrow services.

### BACKGROUND

A large language model (LLMs) is a type of natural language model that communicates via general language understanding and generation. These models are trained on vast quantities of data using large amounts of computational resources to receive natural language input text and repeatedly predicting words or tokens. Large language models can be used for a variety of tasks, such as machine translation, text generation, content summary, and conversational chatbots.

### SUMMARY

One aspect of the disclosure provides a method for providing a data escrow service. The computer-implemented method is executed by data processing hardware that causes the data processing hardware to perform operations. The operations include receiving, from a user device, an access query requesting the data processing hardware generate an access request for allowing a user associated with the user device access to one or more datasets of a plurality of datasets. The access query includes natural language text describing information associated with the one or more datasets of the plurality of datasets. The operations also include determining, using a large language model (LLM) and the access query, the one or more datasets. The operations include generating the access request requesting the user gain temporary access to the one or more datasets. The operations also include providing, to the user device, a notification of the one or more datasets and the access request, the notification not including any data from the one or more datasets.

Implementations of the disclosure may include one or more of the following optional features. In some implementations, the natural language text further describes a question posed by the user that requires data from the one or more datasets to answer. In some of these implementations, the notification includes a data query for querying the one or more datasets for the required data. Determining the one or more datasets may include generating, by the LLM, a plurality of data queries and executing each of the plurality of data queries. Additionally, based on executing each of the plurality of data queries, the operations include selecting the data query and selecting the one or more datasets. In some of these implementations, selecting the data query includes determining, for each respective data query in the plurality of data queries, a plausibility that the respective data query answers the question posed by the user.

In some examples, the access request includes a single-use access request. The access request may include an expiration time period. Optionally, the operations further include providing, to an administrator of the one or more datasets, the access request. In some of these examples, the operations further include, after providing, to the administrator of the one or more datasets, the access request, receiving, from the administrator, approval of the access request and, based on the approval of the access request, providing data from the one or more datasets to the user device. The LLM may execute within a trusted execution environment.

Another aspect of the disclosure provides a system for a data escrow service. The system includes data processing hardware and memory hardware in communication with the data processing hardware. The memory hardware stores instructions that when executed on the data processing hardware cause the data processing hardware to perform operations. The operations include receiving, from a user device, an access query requesting the data processing hardware generate an access request for allowing a user associated with the user device access to one or more datasets of a plurality of datasets. The access query includes natural language text describing information associated with the one or more datasets of the plurality of datasets. The operations also include determining, using a large language model (LLM) and the access query, the one or more datasets. The operations include generating the access request requesting the user gain temporary access to the one or more datasets. The operations also include providing, to the user device, a notification of the one or more datasets and the access request, the notification not including any data from the one or more datasets.

This aspect may include one or more of the following optional features. In some implementations, the natural language text further describes a question posed by the user that requires data from the one or more datasets to answer. In some of these implementations, the notification includes a data query for querying the one or more datasets for the required data. Determining the one or more datasets may include generating, by the LLM, a plurality of data queries and executing each of the plurality of data queries. Additionally, based on executing each of the plurality of data queries, the operations include selecting the data query and selecting the one or more datasets. In some of these implementations, selecting the data query includes determining, for each respective data query in the plurality of data queries, a plausibility that the respective data query answers the question posed by the user.

In some examples, the access request includes a single-use access request. The access request may include an expiration time period. Optionally, the operations further include providing, to an administrator of the one or more datasets, the access request. In some of these examples, the operations further include, after providing, to the administrator of the one or more datasets, the access request, receiving, from the administrator, approval of the access request and, based on the approval of the access request, providing data from the one or more datasets to the user device. The LLM may execute within a trusted execution environment.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for a data escrow service using a large language model.

FIG. 2 is a schematic view of exemplary components of the system of FIG. 1.

FIG. 3 is a flowchart of an example arrangement of operations for a method of a data escrow service using a large language model.

FIG. 4 is a schematic view of an example computing device that may be used to implement the systems and methods described herein.

Like reference symbols in the various drawings indicate like elements.

### DETAILED DESCRIPTION

A major roadblock for many data specialists is the combination of enterprise access controls and the inability to predict whether a given dataset will meaningfully contribute to a specific analysis. For example, if a user attempts to determine revenue for a given business unit, the user may have to separately request access to multiple datasets, potentially incurring a long approval wait time for each request. As enterprises move to add more and more protection around sensitive data (and specialists endeavor to produce insights spanning more and more datasets), the friction will likely continue to increase.

Large language models (LLMs) are capable, given a natural language prompt, of query planning across multiple datasets. When metadata labeling is ambiguous, these models may quickly explore alternatives in parallel. Continuing the previous example, in response to a prompt asking for the revenue of a given business unit, a model may retrieve the relevant business metadata directory and, based on the metadata, propose one or more queries to answer the prompt. With sufficient permissions, the model may execute each of these proposed queries and evaluate the relative plausibility of each (e.g., using one or more simple heuristics, such as “revenue should be in the $XXM range”). This capability significantly reduces the manual effort required by data specialists to identify and access relevant datasets, thereby accelerating the data analysis process and improving the overall productivity of data teams.

Accordingly, in some implementations, a data escrow service includes a data escrow controller that includes a model, such as an LLM. These implementations address these technical problems discussed above by streamlining the data access process, reducing the time and effort required to obtain necessary permissions, and minimizing the risk of unauthorized data exposure. By leveraging LLMs, the system can intelligently predict and request the appropriate datasets, thereby enhancing the efficiency and accuracy of data analysis.

An LLM provides a “data escrow” agent by allowing the user to skip the conventional iterative data acquisition step and instead directly understand what data access is required to answer a specific question. For example, a user asks, “What access request would I need to make to calculate revenue?” In response, the LLM may model and execute possible queries, determine and return whichever query is the most promising or plausible, and/or pre-populate the relevant access request(s) (e.g., a temporary access request or single-use access request) required to execute the query. This approach not only saves time but also reduces the cognitive load on users, enabling them to focus on higher-level analytical tasks rather than administrative procedures. Notably, the “escrow” aspect refers to that any potentially sensitive results from the datasets do not leave the model or controller. Instead, the only information reported may be regarding the viability and/or access needs for the query to be completed. This may be guaranteed purely in software, (e.g., by ensuring that sensitive data is not logged). In other examples, the system instead provides hardware-based confidentiality guarantees, with the model and/or controller executing in a trusted execution environment (TEE) and only allowing specific types of information out of the TEE. These technical benefits ensure that sensitive data remains protected while still providing users with the necessary insights to make informed decisions. Additionally, the use of TEEs enhances the security and trustworthiness of the system, making it suitable for handling highly confidential information.

Thus, the controller boosts the viability of short-term access requests (i.e., versus long-term grants). For example, data users are provided an improved indication of whether a given access request will allow the user to complete their request, which reduces the need to preemptively request broad permissions and avoiding bottlenecks that naturally arise from the traditional iterative request pattern. Additionally, by tying requests to specific queries, the system also increases the viability of pre-query approvals without creating an unmanageable flurry of related requests that a “run and debug” workflow may entail.

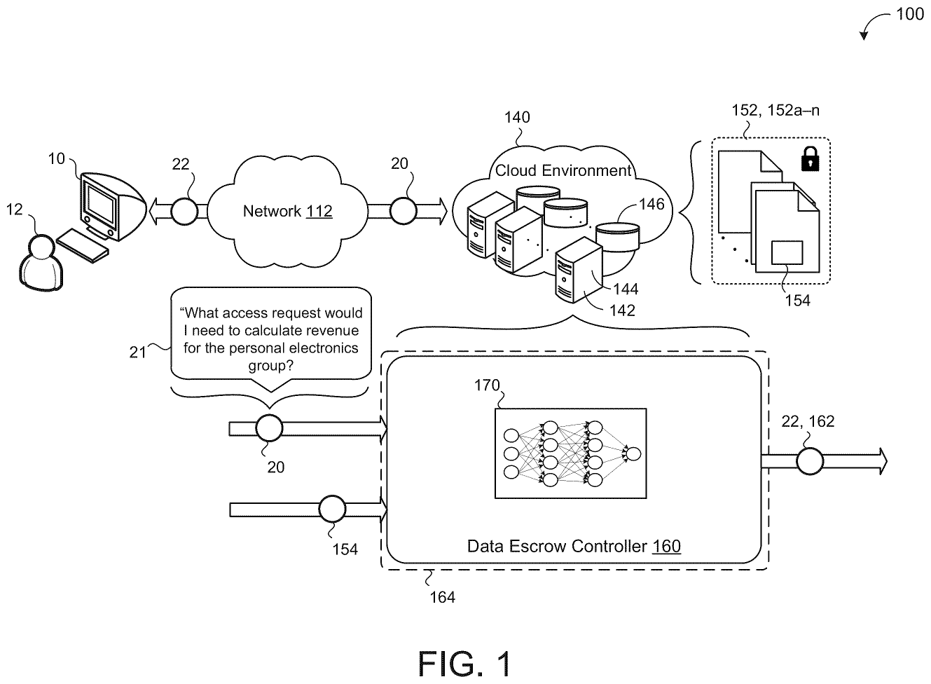

Referring to FIG. 1, in some implementations, a data escrow system 100 includes a remote system 140 in communication with one or more user devices 10 each associated with a respective user 12 via a network 112. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). A data store 148 (i.e., a remote storage device) may be overlain on the storage resources 146 to allow scalable use of the storage resources 146 by one or more of the clients (e.g., the user device 10) or the computing resources 144. The remote system 140 is configured to communicate with the user devices 10 via, for example, the network 112. The user device(s) 10 may correspond to any computing device, such as a desktop workstation, a laptop workstation, or a mobile device (i.e., a smart phone).

The remote system 140 hosts one or more datasets 152, 152a-n. Each dataset 152 includes data 154 relevant to the particular dataset 152. In some examples, one or more of the datasets 152 include confidential, private, or otherwise privileged information (e.g., sensitive business data, medical data, government data, etc.). Each dataset 152 may be subject to an individual access control scheme. That is, each dataset 152 may be governed by an access control scheme that controls who may access (i.e., read, write, and/or modify) the data 154 within the dataset 152. In some examples, the user 12 requires permission (e.g., via an access request 162) to access. For example, the user 12 requires an access request 162 be approved prior to being allowed to query one or more of the datasets 152. In some implementations, multiple access requests 162 are required to access multiple different datasets 152.

The remote system 140 executes a data escrow controller 160. The data escrow controller 160 receives, from a user device 10 associated with a particular user 12, an access query 20. The access query 20 includes a request to access the data 154 of one or more of the datasets 152. In some implementations, the access query 20 includes natural language text 21 (e.g., a natural language prompt) that describes information associated with one or more of the datasets 152. Optionally, the natural language text describes a question or prompt posed by the user 12 that requires data 154 from one or more of the datasets 152 to answer. For example, the access query 20 includes a prompt from the user 12 that includes “what access request would I need to calculate revenue for the personal electronics group?”

The data escrow controller 160 includes a model 170. The model 170 may be a machine learning model, such as a LLM 170. Large language models (LLMs) are advanced machine learning models designed to understand and generate human language. They are trained on vast amounts of text data and can perform a variety of language-related tasks, such as translation, summarization, and question-answering. These models use deep learning techniques, particularly neural networks with many layers (hence ‘large’), to capture the complexities of language. An LLM can generate coherent and contextually relevant text based on the input they receive, making them highly effective for natural language processing applications. Optionally, other types of models are used, such as decision trees, support vector machines (SVMs), and ensemble models, etc.

The data escrow controller 160 determines, using the model 170 and the access query 20, the datasets 152 most likely required to respond to the access query 20. The data escrow controller 160 generates one or more access requests 162 that request the user 12 associated with the access query 20 be granted or gain temporary access to the one or more datasets 152 determined by the model 170. For example, the data escrow controller 160 pre-populates each access request 162 with the information (e.g., user details, dataset details, query details, etc.) required for the submission of the access request 162. These access requests 162 may include single-use access requests, which allow the user 12 to access the dataset(s) 152 a single time via a single query 220 to retrieve the necessary data 154. Alternatively, the access requests 162 may set a limited expiration time period or threshold, defining a period of time (e.g., seconds, minutes, or hours) during which the user 12 may access the requested datasets 152.

In some implementations, the data escrow controller 160 provides identification of the determined datasets 152 and/or the access request(s) 162 to the user 12 via the user device 10. That is, the data escrow controller 160 may generate a notification 22 to notify the user 12 of the datasets 152 required to answer the question within the natural language prompt of the access query 20 and provide the access requests 162 required to obtain such access. Notably, the data escrow controller 160, at this stage, does not provide any data 154 from the datasets 152 to the user 12. Instead, the notification 22 is limited to the viability or the plausibility of the access query 20 and/or what access is required to respond to the access query 20. Optionally, the notification 22 includes one or more queries for querying the datasets 152 for the data 154 necessary to respond to the access query 20 once the user 12 gains access to the datasets 152.

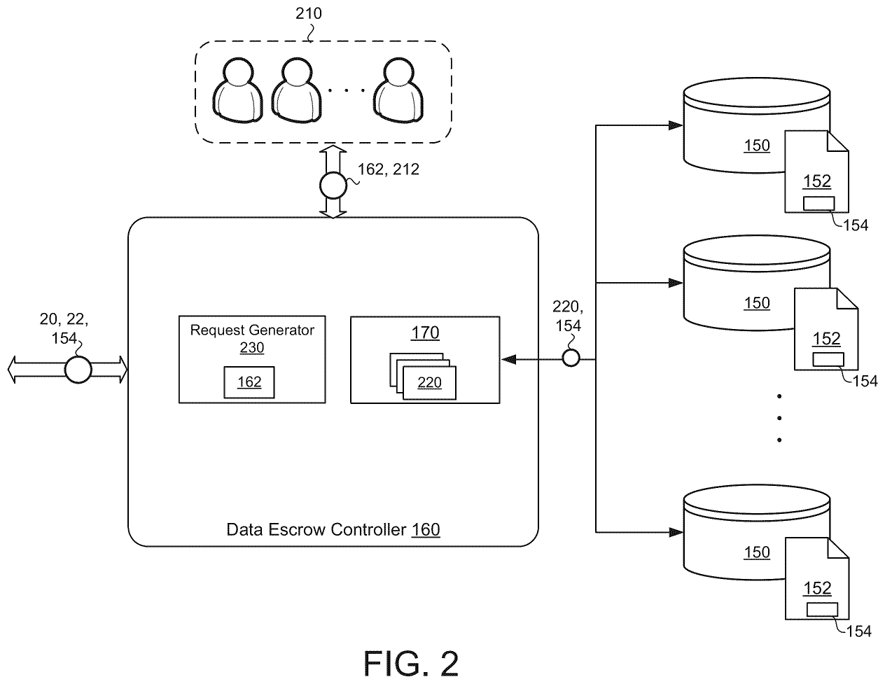

In some implementations, the notification 22 includes a natural language response. For example, a notification 22 may include natural language reciting, “To calculate the revenue for the personal electronics group, you need access to datasets A, B, and C. Please submit the following access requests to proceed.” Another example includes the natural language “Your query to determine the market share of product X requires access to datasets D and E. The access requests have been pre-populated for your convenience.” These notifications 22 may be provided to the user 12 via email, a pop-up message on the user device 10, through a dedicated dashboard within the data escrow system 100, etc. In some examples, the data escrow controller 160 automatically submits the access requests 162 to one or more administrators 210 (FIG. 2) to approve the access requests 162. In other examples, the data escrow controller 160 prompts for authorization from the user 12 to submit the access requests 162. Once the authorization is received (e.g., via interacting with the notification 22 via a graphical user interface executing on the user device 10), the data escrow controller 160 may submit the access requests 162. In yet other examples, the user 12 submits the access requests 162 without the data escrow controller 160.

In some implementations, the data escrow controller 160 and/or the model 170 execute within a trusted execution environment (TEE) 164. A TEE is a secure area of a main processor that ensures sensitive data is stored, processed, and protected in an isolated and trusted environment. It provides an execution space that offers higher security than the main operating system. In these examples, the TEE may be at least partly responsible for ensuring that data 154 from the datasets 152 does not inadvertently leak from the TEE (i.e., to the user 12 or others). This is achieved through hardware-based confidentiality guarantees, which ensure that only specific types of information can exit the TEE. The TEE uses encryption and access controls to prevent unauthorized access and data breaches, ensuring that sensitive data remains secure even if the main system is compromised. Optionally, some or all of the data escrow controller 160 executes on the user device 10. For example, a portion of the data escrow controller 160 executes on the user device 10 and a portion of the data escrow controller 160 (e.g., a portion including the model 170) executes on the remote system 140.

Referring now to FIG. 2, the data escrow controller 160, in some implementations, generates a plurality of queries 220. Each query 220 is configured to retrieve data 154 from one or more of the datasets 152. Optionally, the model 170, based on the access query 20 (e.g., the natural language prompt of the access query 20), generates and executes each query 220 against the datasets 152. The model 170 and/or the data escrow controller 160 may evaluate the data 154 retrieved via the queries 220 to determine which query 220 is most likely to accurately respond to the question posed by the access query 20. In some examples, the data escrow controller 160 selects the most plausible data query 220 and selects the datasets 152 that the selected query 220 queries. The plausibility of each query 220 may be based on a heuristic. For example, when the question in the access query is “what access request would I need to calculate revenue for the personal electronics group?” a corresponding heuristic may be “revenue should be above $10 M and below $20 M.” The heuristic(s) may be provided by the user 12 (e.g., via the access query 20) or determined by the data escrow controller 160 or model 170 via the data 154 of the datasets 152. For example, the model may use heuristics such as expected data ranges or patterns to assess plausibility based on historical data or known benchmarks.

In some implementations, the data escrow controller 160 includes a request generator 230. The request generator 230, based on the selected datasets 152, generates one or more access requests 162. Each access request 162 requests that the user 12 associated with the access query 20 be granted temporary permission (e.g., limited to a threshold number of accesses and/or limited by a threshold period of time) to access the datasets 152 to answer the question provided by the access query 20. The access requests 162 may include information such as user details, dataset details, and/or query details. The system may obtain this information from the user device 10 or user 12, the access query 20, and/or the datasets 152 themselves.

In some examples, the access request 162 comprises a single-use access request. That is, the access request 162, once approved, only allows the user 12 to access the dataset(s) 152 a single time via a single query 220 in order to retrieve the necessary data 154. In other examples, the access request 162 sets for a limited expiration time period. The expiration time period defines a period of time that the user 12 may access the requested datasets 152. The expiration time period may be very limited (e.g., seconds or minutes or hours).

In some examples, the data escrow controller 160 automatically (i.e., without user input) provides the generated access requests 162 to one or more administrators 210 of the datasets 152. The administrators 210 have the authority to approve the access requests 162 and grant the user 12 temporary access to the data 154 of the datasets 152. Optionally, the administrators 210 provide an access request approval 212 to the data escrow controller 160. Once the data escrow controller 160 has received each access request approval 212 required to execute the selected query 220, the data escrow controller 160 may automatically retrieve the data 154 associated with the selected query 220 and provide the data 154 to the user 12. In some examples, the model 170 generates a natural language response that includes the data 154 from the datasets 152. The response may be included in the notification 22.

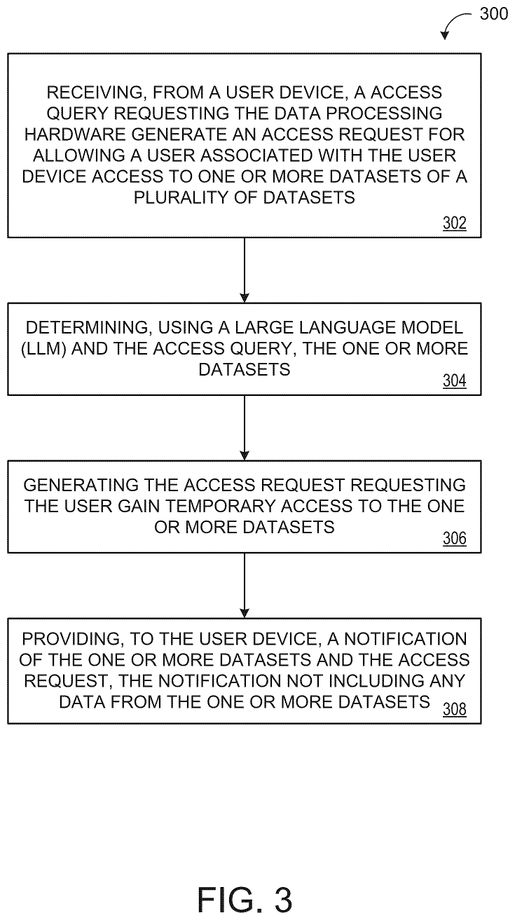

FIG. 3 is a flowchart of an exemplary arrangement of operations for a method 300 of providing a data escrow service using an LLM. The method 300, when executed by data processing hardware 144, causes the data processing hardware 144 to perform operations. The method 300, at operation 302, includes receiving, from a user device 10, an access query 20 requesting the data processing hardware 144 generate an access request 162 for allowing a user 12 associated with the user device 10 access to one or more datasets 152 of a plurality of datasets 152. The access query 20 includes natural language text describing information associated with the one or more datasets 152 of the plurality of datasets 152. This approach addresses a major roadblock for data specialists by streamlining the process of requesting access to multiple datasets, which is cumbersome to submit and traditionally incurs long approval wait times.

At operation 304, the method 300 includes determining, using the LLM 170 and the access query 20, the one or more datasets 152. The LLM's capability to interpret natural language prompts and propose relevant queries enhances the efficiency of identifying necessary datasets, even when metadata labeling is ambiguous. The method 300, at operation 306, includes generating the access request 162 requesting the user 12 gain temporary access to the one or more datasets 152. This reduces the need for broad, preemptive access requests and minimizes bottlenecks. At operation 308, the method 300 includes providing, to the user device 10, a notification 22 of the one or more datasets 152 and the access request 162. The notification 22 does not include any data 154 from the one or more datasets 152. Accordingly, this method leverages the escrow aspect of the service, where sensitive results do not leave the model or controller, thus maintaining data security and providing a more efficient and secure data access process.

Thus, implementations herein utilize models 170 such as LLMs to streamline access requests for datasets. Users 12 can query datasets 152 using natural language prompts, allowing the LLM 170 to determine necessary access requests 162. This improves the efficiency of data access while maintaining data confidentiality. A data escrow controller 160 may model and execute possible queries 220, determine the most promising or plausible query 220, and pre-populate the relevant access requests 162 required to execute the query 220. Sensitive results remain within the model 170 or controller 160, ensuring data security.

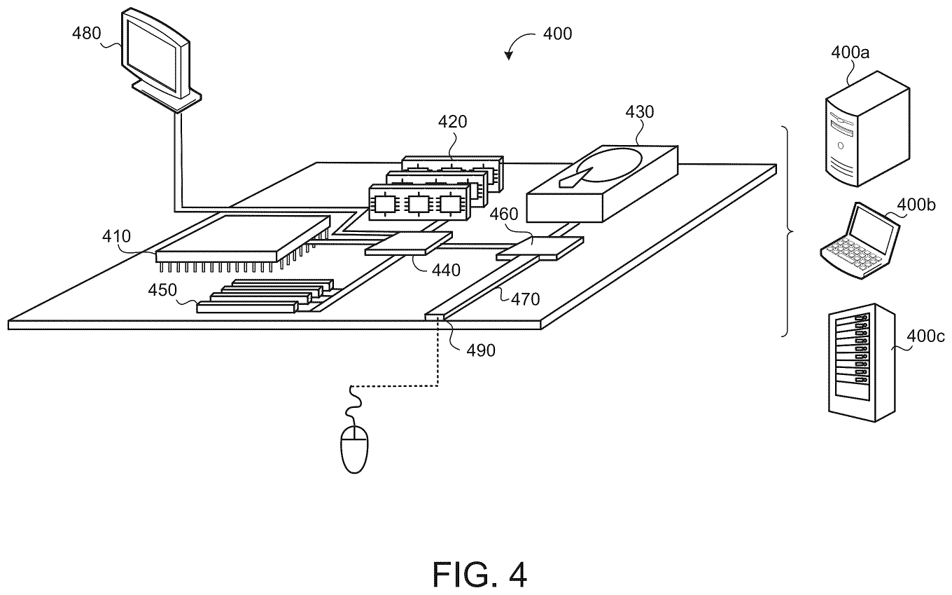

FIG. 4 is a schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410, memory 420, a storage device 430, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high-speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
receiving, from a user device, an access query requesting the data processing hardware generate an access request for allowing a user associated with the user device access to one or more datasets of a plurality of datasets, the access query comprising natural language text describing information associated with the one or more datasets of the plurality of datasets;
determining, using a large language model (LLM) and the access query, the one or more datasets;
generating the access request requesting the user gain temporary access to the one or more datasets; and
providing, to the user device, a notification of the one or more datasets and the access request, the notification not including any data from the one or more datasets.

2. The method of claim 1, wherein the natural language text further describes a question posed by the user that requires data from the one or more datasets to answer.

3. The method of claim 2, wherein the notification comprises a data query for querying the one or more datasets for the required data.

4. The method of claim 3, wherein determining the one or more datasets comprises:
generating, by the LLM, a plurality of data queries;
executing each of the plurality of data queries; and
based on executing each of the plurality of data queries:
selecting the data query; and
selecting the one or more datasets.

5. The method of claim 4, wherein selecting the data query comprises determining, for each respective data query in the plurality of data queries, a plausibility that the respective data query answers the question posed by the user.

6. The method of claim 1, wherein the access request comprises a single-use access request.

7. The method of claim 1, wherein the access request comprises an expiration time period.

8. The method of claim 1, wherein the operations further comprise providing, to an administrator of the one or more datasets, the access request.

9. The method of claim 8, wherein the operations further comprise, after providing, to the administrator of the one or more datasets, the access request:
receiving, from the administrator, approval of the access request; and
based on the approval of the access request, providing data from the one or more datasets to the user device.

10. The method of claim 1, wherein the LLM executes within a trusted execution environment.

11. A system comprising:
data processing hardware; and
memory hardware in communication with the data processing hardware, the memory hardware storing instructions that when executed on the data processing hardware cause the data processing hardware to perform the operations comprising:
receiving, from a user device, an access query requesting the data processing hardware generate an access request for allowing a user associated with the user device access to one or more datasets of a plurality of datasets, the access query comprising natural language text describing information associated with the one or more datasets of the plurality of datasets;
determining, using a large language model (LLM) and the access query, the one or more datasets;
generating the access request requesting the user gain temporary access to the one or more datasets; and
providing, to the user device, a notification of the one or more datasets and the access request, the notification not including any data from the one or more datasets.

12. The system of claim 11, wherein the natural language text further describes a question posed by the user that requires data from the one or more datasets to answer.

13. The system of claim 12, wherein the notification comprises a data query for querying the one or more datasets for the required data.

14. The system of claim 13, wherein determining the one or more datasets comprises:
generating, by the LLM, a plurality of data queries;
executing each of the plurality of data queries; and
based on executing each of the plurality of data queries:
selecting the data query; and
selecting the one or more datasets.

15. The system of claim 14, wherein selecting the data query comprises determining, for each respective data query in the plurality of data queries, a plausibility that the respective data query answers the question posed by the user.

16. The system of claim 11, wherein the access request comprises a single-use access request.

17. The system of claim 11, wherein the access request comprises an expiration time period.

18. The system of claim 11, wherein the operations further comprise providing, to an administrator of the one or more datasets, the access request.

19. The system of claim 18, wherein the operations further comprise, after providing, to the administrator of the one or more datasets, the access request:
receiving, from the administrator, approval of the access request; and
based on the approval of the access request, providing data from the one or more datasets to the user device.

20. The system of claim 11, wherein the LLM executes within a trusted execution environment.
